(19) United States
(12) Patent Application Publication
(10) Pub. No.: US 2019/0002610 A1
(43) Pub. Date: Jan. 3, 2019

(54) PROCESS FOR PREPARING POLYMER COMPOSITIONS

(71) Applicant: BOREALIS AG, Vienna (AT)

(72) Inventors: Wilfried Töltsch, Marchtrenk (AT); Luigi Resconi, Neuhofen an der Krems (AT); Kristin Reichelt, Neuhofen/Krems (AT)

(21) Appl. No.: 15/735,891

(22) PCT Filed: Jun. 29, 2016
(86) PCT No.: PCT/EP2016/065147

§ 371 Date: Dec. 12, 2017

(30) Foreign Application Priority Data
Jun. 30, 2015 (EP) 15174579.1

(51) Int. Cl. C08F 210/06; C08J 5/18; B32B 27/08; B32B 27/32

(52) U.S. Cl. CPC C08F 210/06; C08J 5/18; B32B 27/08; B32B 2307/518; C08J 2323/14; C08F 2800/20; B32B 27/32

(57) ABSTRACT

The present invention relates to an olefin polymerization process, wherein propylene and a C4 to C10 α-olefin monomer, preferably 1-butene- and optionally ethylene are reacted in the presence of a Ziegler-Natta catalyst so as to obtain a polypropylene, wherein the polypropylene comprises C4 to C10 α-olefin, preferably 1-butene-derived comonomer units in an amount of from 0,5 to 15 wt % and ethylene-derived comonomer units in an amount of 0 to 3 wt %, and wherein the Ziegler-Natta catalyst comprises i) an external donor of the formula (I): (R³)_{z}(R²O)_{y}Si(R¹)ₓ, and ii) a solid catalyst component being free of external carrier material.

The present invention relates to an olefin polymerization process, wherein propylene and an α-olefin of 4 to 10 C atoms and optionally ethylene are reacted in the presence of a Ziegler-Natta catalyst comprising an external donor. Further, the invention is directed to the propylene polymer compositions prepared from the process of the invention and use of said propylene polymer compositions for producing articles.

Good comonomer incorporation, i.e. good comonomer conversion and comonomer response are desired to reach better process economics and to avoid the need of extensive after-treatment steps for removing residual hydrocarbons. Especially higher monomers containing four or more carbon atoms tend to be less reactive and thus cause problems, like deterioration in organoleptic properties of the polymer. However, using such monomers is on the other hand advantageous for many polymer properties.

Polypropylenes are suitable for many applications. It is known that polypropylene comprising comonomer units derived from a higher alpha-olefin (such as 1-butene or 1-hexene) and optionally ethylene-derived comonomer units is useful for preparing polypropylene films such as blown films, cast films and polymer layers for multilayer films. Among other articles, flexible packaging can be prepared from such polypropylene materials.

A polypropylene having comonomer units of a higher alpha-olefin (e.g. a C₄₋₁₀ alpha-olefin) and optionally ethylene comonomer units can be prepared in the presence of a Ziegler-Natta catalyst. However, in order to have an efficient process, it is important that the catalyst has a high reactivity towards the C₄₋₁₀ alpha-olefin used as comonomer to ensure satisfactory process economics resulting in reduced need of the removal of non-reacted monomers from the polymer powder in an additional after-treatment step.

Typically, propylene is of higher reactivity than a C₄₋₁₀ alpha-olefin. Thus, for the preparation of propylene polymers having comonomer units derived from a higher alpha-olefin and optionally from ethylene, it is very important that the used catalyst has a sufficiently high reactivity towards the C₄₋₁₀ alpha-olefin component.

Depending on the final application, the polypropylene composition is subjected to further process steps such as extrusion or molding steps (e.g. cast molding, blow molding, extrusion coating etc.). The propylene polymer composition should have product properties which are consistent with the intended final application and have suitable processability properties in the desired process.

In many applications the polymer should have a low amount of xylene solubles (XS). Especially, food packaging applications require low XS values. Thus, a catalyst should comply with both requirements, i.e. having a high reactivity towards a C₄₋₁₀ α-olefin comonomer and enabling the preparation of propylene polymer composition comprising a C₄₋₁₀ α-olefin monomer and optionally ethylene and having low XS vs the amount of comonomer(s) in the final polymer.

Propylene polymer compositions, like propylene polymers comprising higher comonomers and optionally ethylene, are as such known in the art. However, there is an increased demand for improved or fine-tuned properties of the polymer and process.

Catalyst residues, especially catalyst carrier residues, like silica or MgCl₂ residues, might be harmful in final products, especially in film products.

WO9858971 discloses propylene terpolymer compositions comprising a mixture of two different terpolymer compositions. Polymer is produced in a process comprising a combination of slurry and gas phase reactors. A MgCl₂-supported Ziegler-Natta catalyst is used therein.

WO2009/019169 discloses a process for producing propylene terpolymer comprising as comonomers ethylene and an alpha-olefin of 4-8 C atom. Process is carried out in gas-phase reactor comprising two interconnected polymerization zones. As catalyst is used MgCl₂ supported Ziegler-Natta catalyst with dicyclopentyldimethoxysilane as external electron donor. XS values are disclosed to be higher than 9 wt-%

EP2558508 discloses a propylene-ethylene-hexene terpolymer produced by using a MgCl₂ supported Ziegler-Natta catalyst with dicyclopentyldimethoxysilane as external electron donor. The terpolymer produced is defined to have hexene content of 2 to 4 wt-% and ethene content of 1 to 2.5 wt-% and produced in two interconnected fluidized bed reactor.

WO 2009/077287 A1 describes a process for the preparation of polypropylene comprising 1-hexene derived comonomer units. The C3/C6 copolymer is prepared in the presence of a MgCl₂ supported Ziegler-Natta catalyst comprising an external donor such as thexyltrimethoxysilane. The process described in WO 2009/077287 A1 results in a polypropylene having a high amount of xylene solubles. In comparative examples of WO 2009/077287 propylene-butene copolymers with 15 wt-% of butene were used in film preparation. However, no process or catalyst details are given for the polymers used in comparative film products.

G. Collina, L. Noristi, C. A. Stewart, J. Mol. Cat. A: Chem. 1995, 99, 161-165, discloses studies of stereospecificity of homo- and propylene-co-butene copolymers synthetized by using specific silanes as external donors. In the two copolymer examples xylene solubles are high with comonomer content below 10 wt %.

Low XS values and at the same time high comonomer incorporation is not disclosed in prior art documents. Further, in all prior art documents listed above, a catalyst supported on an external carrier is used.

As indicated above, there is room to improve the process for producing propylene polymer compositions comprising at least a C4 to C10 α-olefin in the presence of Ziegler-Natta catalysts to provide polymers with improved and desired properties, especially polymers with low XS vs. the amount of comonomer.

In order to avoid use of external carrier material for producing solid catalyst components it has been developed a specific process for catalyst manufacturing. Such catalysts and preparation thereof are described e.g. in WO 03/000754, WO 03/000757, WO 2007/077027, WO 2012/007430, EP2610271, EP 261027 and EP2610272 which are incorporated here by reference.

Ziegler-Natta catalysts for producing propylene polymers comprise in addition to the solid catalyst component also cocatalysts, typically organoaluminum compounds and typically external electron donors.

Alkoxy silane type compounds are typically used as an external electron donor in propylene (co)polymerization process, and are as such known and described in patent literature. E.g. EP0250229, WO2006104297, EP0773235, EP0501741 and EP0752431 disclose different alkoxy silanes used as external donors in polymerizing propylene.

Thus, it is an object of the present invention to provide a process for preparing a propylene polymer composition comprising comonomer units derived from an α-olefin of 4 to 10 C atoms, preferably from α-olefin of 4 to 6 C atoms and optionally from ethylene. According to the process of the invention the comonomer of 4 to 10 C atoms is incorporated into the polymer chain at high yield, i.e. with a high conversion rate, and resulting in propylene polymer composition having low amount of xylene solubles (XS).

Especially the object of the present invention is to provide a process for preparing propylene polymer composition having comonomer units derived from 1-butene and optionally ethylene and having desired low XS values.

Further, an object of the present invention is to provide a propylene polymer composition obtainable, preferably obtained by the process of the invention and use thereof for producing articles.

Still a further object of the present invention is to use the catalyst comprising a solid Ziegler-Natta catalyst component being free of external carrier and a specific external electron donor in a process for producing propylene polymer compositions as defined in the present application.

According to a first aspect of the present invention, the object is solved by an olefin polymerization process, wherein propylene and an α-olefin comonomer of 4 to 10 C atoms, and optionally ethylene are reacted in the presence of a Ziegler-Natta catalyst so as to obtain a propylene polymer composition, wherein the propylene polymer comprises an α-olefin of 4 to 10 C atoms-derived comonomer units in an amount of from 0,5 to 15 wt % and ethylene-derived comonomer units in an amount of 0 wt-% to 3 wt %,

wherein the Ziegler-Natta catalyst comprises
i) an external donor of the following formula (I)

(R³)_{z}(R²O)_{y}Si(R¹)ₓ (I)
wherein
x is 1; y is 2 or 3; and z is 0 or 1; under the provision that x+y+z=4;
R¹ is an organic residue of the following formula (II)

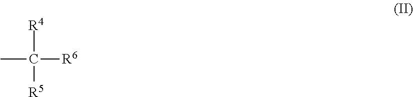

wherein
the carbon atom bonded to the Si atom is a tertiary carbon atom and each of the residues R⁴, R⁵ and R⁶ bonded to the tertiary carbon atom is, independently from each other, a C₁₋₄ alkyl, or two of R⁴, R⁵ and R⁶, together with the tertiary carbon atom C they are attached to, can be part of a carbocycle of 4-10 carbon atoms;
R² is a linear C₁₋₄ alkyl
R³ is a C₁₋₄ alkyl, and
ii) a solid Ziegler-Natta catalyst component, which is free of any external carrier material.

Thus, the essential features of the present invention are to use in the polymerization process the specific external donor as defined above, and a solid Ziegler-Natta catalyst component, which is free of any external carrier.

The solid Ziegler-Natta catalyst component used in the present invention comprises a compound of Group 1 to 3 metal, a compound of a Group 4 to 6 transition metal (Nomenclature of Inorganic Chemistry, IUPAC 1988) and an internal electron donor. These components are not supported on an external support, as typically in prior art catalysts. Thus, the catalyst component is free of any external carrier material. The solid catalyst component used in the present invention is prepared by precipitation or emulsion-solidification method as described later in the application.

According to the process of the present invention, where copolymerization of propylene with an α-olefin comonomer of 4 to 10 C atoms and optionally with ethylene is carried out in the presence of a Ziegler-Natta catalyst comprising the specific external donor and the specific solid catalyst component as specified above, the α-olefin comonomer of 4 to 10 C atoms, is very efficiently incorporated into the polymer chain, while still achieving desirable product properties such as low XS. Further, possible problems with carrier residues in final products, like in films can be avoided. As will be discussed below in further detail, a Ziegler-Natta catalyst comprising the specific silane compound of formula (I) acting as an external electron donor has a very high reactivity towards said α-olefin comonomer. Thus, less α-olefin comonomer of 4 to 10 C atoms has to be fed to the polymerization reactor for accomplishing a certain content of α-olefin of 4 to 10 C atoms derived comonomer units in the final polymer and/or less non-reacted α-olefin comonomer of 4 to 10 C atoms has to be removed from the polymer powder.

Preferably the α-olefin comonomer of 4 to 10 C atoms is an α-olefin comonomer of 4 to 6 C atoms, especially 1-butene.

In the Formulas I and II, it is preferred that y is 2 or 3, z is 0 or 1, R² is a linear C₁₋₄ alkyl, preferably methyl, R³ is C₁₋₄ alkyl, and R⁴, R⁵ and R⁶ are independently from each other a linear C₁₋₄ alkyl.

According to another preferred embodiment R⁴, R⁵ and R⁶ are methyl or ethyl. Still according to a further preferred embodiment R², R⁴, R⁵ and R⁶ are all methyl.

According to another preferred embodiment y is 3, z is 0, R², R⁴, R⁵ and R⁶ are methyl.

According to another preferred embodiment y is 2, z is 1, R² is methyl, R³ is methyl, ethyl or iso-propyl, and R⁴, R⁵ and R⁶ are methyl, most preferably y is 2, z is 1, R², R³, R⁴, R⁵ and R⁶ are all methyl.

The terms external electron donor, external donor and donor have the same meaning in the present application and the terms are interchangeable.

As indicated above, the solid Ziegler-Natta catalyst component used in the present invention is a solid Ziegler-Natta catalyst component comprising as essential components compounds of Group 1 to 3 metal and Group 4 to 6 transition metal and an internal electron donor and optionally a compound of Group 13 metal.

The solid Ziegler-Natta catalyst component is free of any external carrier material. Preferably, particles of the solid catalyst component have a surface area below 20 g/m², more preferably below 10 g/m² or even below 5 g/m², which is below the detection limit.

Suitable internal electron donors are, among others, 1,3-diethers (di)esters of (di)carboxylic acids, like phthalates, maleates, substituted maleates, benzoates, and succinates or derivatives thereof. The internal electron donor is understood to mean a donor compound being part of the solid catalyst component, i.e. added during the synthesis of the catalyst component. The terms internal electron donor and internal donor have the same meaning in the present application and the terms are interchangeable.

Group 1 to 3 metal compound is preferably Group 2 metal compound, and especially a magnesium compound; Group 4 to 6 metal compound is preferably a Group 4 metal compound, more preferably a titanium compound, especially titanium tetrachloride, and the optional Group 13 metal compound is preferably an aluminum compound.

The solid catalyst component used in the present invention is prepared in the absence of any external carrier material according to the general procedure comprising contacting a solution of Group 2 metal alkoxy compound with an internal electron donor, or a precursor thereof, and with at least one compound of a transition metal of Group 4 to 6 in an organic liquid medium, and obtaining the solid catalyst component particles.

According to one embodiment of the general procedure the solid catalyst component used in the present invention is prepared by the process comprising
A. preparing a solution of Group 2 metal complex by reacting a Group 2 metal alkoxy compound and an electron donor or a precursor thereof in a reaction medium comprising C₆-C₁₀ aromatic liquid;
B. reacting said Group 2 metal complex with at least one compound of a transition metal of Group 4 to 6 and
C. obtaining the solid catalyst component particles.

In one preferred embodiment the solid catalyst component used in the present invention is not only free of any external support (or carrier) material, but is also prepared without any phthalic compounds typically used as internal donors or internal donor precursors.

Thus, according to one preferred embodiment the catalyst component without any phthalic compounds is prepared according to the following procedure:

a) providing a solution of
a₁) at least a Group 2 metal alkoxy compound (Ax) being the reaction product of a Group 2 metal compound and an alcohol (A) comprising in addition to the hydroxyl moiety at least one ether moiety optionally in an organic liquid reaction medium; or
a₂) at least a Group 2 metal alkoxy compound (Ax′) being the reaction product of a Group 2 metal compound and an alcohol mixture of the alcohol (A) and a monohydric alcohol (B) of formula ROH, optionally in an organic liquid reaction medium; or
a₃) a mixture of the Group 2 metal alkoxy compound (Ax) and a Group 2 metal alkoxy compound (Bx) being the reaction product of a Group 2 metal compound and the monohydric alcohol (B), optionally in an organic liquid reaction medium; or
a₄) Group 2 metal alkoxy compound of formula M(OR₁)ₙ(OR₂)ₘX₂₋ₙ₋ₘ or mixture of Group 2 alkoxides M(OR₁)_{n′}X_{2-n′} and M(OR₂)_{m′}X_{2-m′}, where M is Group 2 metal, X is halogen, R₁ and R₂ are different alkyl groups of C₂ to C₁₆ carbon atoms, and 0≤n<2; 0≤m<2 and n+m≤2, provided that both n and m≠0, 0<n′≤2 and 0<m′≤2; and
   b) adding said solution from step a) to at least one compound of a transition metal of Group 4 to 6 and
   c) obtaining the solid catalyst component particles, and
   adding a non-phthalic internal electron donor at any step prior to step c).

In this embodiment the internal donor is thus added to the solution of step a) or to the transition metal compound before adding the solution of step a) into said transition metal compound, or added after combining the solution of step a) with the transition metal compound.

According to the general procedures above the solid catalyst component can be obtained via precipitation method or via emulsion-solidification method depending on the physical conditions, especially temperature used in different contacting steps. Emulsion is also called in the present application liquid/liquid two-phase system.

The catalyst chemistry is independent on the selected preparation method, i.e. whether said precipitation or emulsion-solidification method is used.

In the precipitation method combination of the solution of step A) or a) with the at least one transition metal compound in step B) or b) is carried out, and the whole reaction mixture is kept, above 50° C., more preferably within the temperature range of 55 to 110° C., more preferably within the range of 70 to 100° C., to secure the full precipitation of the catalyst component in form of a solid particles in step C) or c).

In emulsion-solidification method in step B) or b) the solution of step A) or a) is typically added to the at least one transition metal compound at a lower temperature, such as from −10 to below 50° C., preferably from −5 to 30° C. During agitation of the emulsion the temperature is typically kept at −10 to below 40° C., preferably from −5 to 30° C. Droplets of the dispersed phase of the emulsion form the active catalyst composition. Solidification (step C) or c)) of the droplets is suitably carried out by heating the emulsion to a temperature of 70 to 150° C., preferably to 80 to 110° C.

Preferably the Group 2 metal is magnesium and the transition metal compound of Group 4 is preferably a titanium compound, most preferably TiCl₄.

Preferred internal electron donors are (di)esters of aromatic (di)carboxylic acids. Said aromatic carboxylic acid ester or diester can be formed in situ by reaction of an aromatic carboxylic acid chloride or diacid chloride with a C₂-C₁₆ alkanol and/or diol, and is preferable di-2-ethyl-hexyl phthalate.

Preferred non-phthalic electron donors are (di)esters of non-phthalic (di)carboxylic acids, 1,3-diethers and derivatives thereof. Especially preferred non-phthalic donors are (di)esters of dicarboxylic acids, in particular (di)esters belonging to a group comprising malonates, maleates, substituted maleates, succinates, glutarates, cyclohexene-1,2-dicarboxylates and benzoates, and any derivatives thereof. More preferred examples are e.g. substituted maleates, most preferably citraconates.

In a preferred embodiment in step a) the solution of a₂) or a₃) are used, i.e. a solution of (Ax′) or a solution of a mixture of (Ax) and (Bx).

Illustrative examples of alcohols (A) are glycol monoethers. Preferred alcohols (A) are C₂ to C₄ glycol monoethers, wherein the ether moieties comprise from 2 to 18 carbon atoms, preferably from 4 to 12 carbon atoms. Preferred examples are 2-(2-ethylhexyloxy)ethanol, 2-butyloxy ethanol, 2-hexyloxy ethanol, 1,3-propylene-glycol-monobutyl ether and 3-butoxy-2-propanol, more preferred alcohols (A) being 2-(2-ethylhexyloxy)ethanol, 1,3-propylene-glycol-monobutyl ether and 3-butoxy-2-propanol. A particularly preferred alcohol (A) is 3-butoxy-2-propanol.

Illustrative monohydric alcohols (B) are of formula ROH, with R being straight-chain or branched C₂-C₁₆ alkyl residue, preferably C₄ to C₁₀, more preferably C₆ to C₈ alkyl residue. The most preferred monohydric alcohol is 2-ethyl-1-hexanol or octanol.

Preferably a mixture of Mg alkoxy compounds (Ax) and (Bx) or mixture of alcohols (A) and (B), respectively, are used and employed in a mole ratio of Bx:Ax or B:A from 10:1 to 1:10, more preferably 6:1 to 1:6, still more preferably 5:1 to 1:3, most preferably 5:1 to 3:1.

Magnesium alkoxy compound may be a reaction product of alcohol(s), as defined above, and a magnesium compound selected from dialkyl magnesiums, alkyl magnesium alkoxides, magnesium dialkoxides, alkoxy magnesium halides and alkyl magnesium halides. Further, magnesium dialkoxides, magnesium diaryloxides, magnesium aryloxyhalides, magnesium aryloxides and magnesium alkyl aryloxides can be used. Alkyl groups can be a similar or different C₁-C₂₀ alkyl, preferably C₂-C₁₀ alkyl. Typical alkyl-alkoxy magnesium compounds, when used, are ethyl magnesium butoxide, butyl magnesium pentoxide, octyl magnesium butoxide and octyl magnesium octoxide. Preferably the dialkyl magnesiums are used. Most preferred dialkyl magnesiums are butyl octyl magnesium or butyl ethyl magnesium.

It is also possible that magnesium compound can react in addition to the alcohol (A) and alcohol (B) also with a polyhydric alcohol (C) of formula R″ (OH)ₘ to obtain said magnesium alkoxide compounds. Preferred polyhydric alcohols, if used, are alcohols, wherein R″ is a straight-chain, cyclic or branched C₂ to C₁₀ hydrocarbon residue, and m is an integer of 2 to 6.

The magnesium alkoxy compounds of step A) or a) are thus selected from the group consisting of magnesium dialkoxides, diaryloxy magnesiums, alkyloxy magnesium halides, aryloxy magnesium halides, alkyl magnesium alkoxides, aryl magnesium alkoxides and alkyl magnesium aryloxides. In addition a mixture of magnesium dihalide and a magnesium dialkoxide can be used.

The solid particulate product obtained by precipitation or emulsion-solidification method may be washed at least once, preferably at least twice, most preferably at least three times with an aromatic and/or aliphatic hydrocarbons, preferably with toluene, heptane or pentane and/or with TiCl₄. Washing solutions can also contain additional amount of the internal donor used and/or compounds of Group 13 metal, preferably aluminum compounds of the formula AlR₃₋ₙXₙ, where R is an alkyl and/or an alkoxy group of 1 to 20, preferably of 1 to 10 carbon atoms, X is a halogen and n is 0, 1 or 2. Typical Al compounds comprise triethylaluminum and diethylaluminum chloride. Aluminum compounds can also be added during the catalyst synthesis at any step before the final recovery, e.g. in emulsion-solidification method the aluminium compound can be added and brought into contact with the droplets of the dispersed phase of the agitated emulsion.

The obtained catalyst component can further be dried, as by evaporation or flushing with nitrogen, or it can be slurried to an oily liquid without any drying step.

The finally obtained Ziegler-Natta catalyst component is desirably in the form of particles having generally a mean particle size range of 5 to 200 μm, preferably 10 to 100 μm.

Particles of the solid catalyst component have surface area below 20 g/m², more preferably below 10 g/m², or even below the detection limit of 5 g/m².

Typically the amount of Ti is 1 to 6 wt-%, amount of Mg is 10 to 20 wt-% and amount of internal donor is 10 to 40 wt-% in the solid catalyst component.

The catalyst component prepared by emulsion-solidification method is preferably used in the present invention. The catalyst component prepared by emulsion-solidification method is in the form of solid spherical particles having a low surface area being below 20 g/m², more preferably below 10 g/m². Said particles are also typically of compact structure with low porosity. Furthermore, these catalysts are featured by a uniform distribution of catalytically active sites thorough the catalyst particles. The dispersed phase of the emulsion is in the form of liquid droplets and forms the catalyst part, which is transformed to solid catalyst particles during the solidification step as described above.

Catalyst components used in the present invention and preparation methods thereof are described e.g. in WO-A-2003/000757, WO-A-2003/000754, WO-A-2004/029112 and WO2007/137853. The catalyst components containing no phthalate compounds are disclosed in particular in e.g. WO 2012/007430, EP2610271, EP 261027 and EP2610272 which are incorporated here by reference. As indicated above, catalyst prepared without any phthalic compounds are preferred in the present invention.

As indicated above, the propylene polymer composition of the present invention comprises C4 to C10 α-olefin, preferably C4 to C6 α-olefin, most preferably 1-butene-derived comonomer units in an amount of from 0.5 wt % to 15 wt %. Preferably, the amount of 1-butene-derived comonomer units in the polypropylene is from 1 wt % to 12 wt %, even more preferably from 2 wt % to 12 wt %, in particular 2 wt % to 10 wt %. In some preferred embodiments 1-butene content may be in the range of 3 wt % to 10 wt %, 4 wt % to 10 wt %, 3 wt % to 9 wt %, or 4 wt % to 9 wt %. The essential feature of the present invention is that the propylene polymer compositions have low XS values. The XS values depend on several factors, one of which being the total amount of comonomer, but in any case XS values at most 3,5 wt % are preferred, when only 1-butene is used as comonomer. Even lower XS values can be achieved, when the polymer is produced in the presence of the catalyst not containing any phthalic compounds. Thus, in a preferred embodiment the XS values are at most 3 wt %. Such low XS values are achievable, even with the 1-butene comonomer amount of more than 6 wt %. In case ethylene is used as an additional comonomer, XS values tend to be higher, but anyway XS values at most 5,5 wt % are obtained with the catalyst of the present invention.

The propylene polymer composition prepared according to the process of the present invention is formed from propylene and from comonomers selected from C4-C10 α-olefin, preferably from C4 to C8 α-olefin, more preferably from C4 to C6 α-olefin. Most preferably the α-olefin comonomer is 1-butene. Alternatively the comonomers are selected from the α-olefin comonomers as defined above and ethylene. Thus the propylene polymer produced is most preferably propylene/1-butene comonomer or propylene/1-butene/ethylene terpolymer.

The polypropylene prepared by the process of the present invention may also contain ethylene-derived comonomer units in an amount of up to 3 wt %, more preferably 0.5 wt % to 2.5 wt %, most preferably 0.5 to 1.5 wt %.

Presence of ethylene as additional comonomer decreases the melt temperature of the polymer. Thus, melt temperature of propylene/l-butene/ethylene terpolymers produced by the method of the present invention may be below 142° C., preferably below 140° C., even below 138° C. However, the amount of comonomers has a high effect on the Tm.

Preferably, the polypropylene produced by the process of the invention has a melt flow rate MFR₂ of from 0,5 to 100 g/10 min, more preferably 1.0 to 30 g/10 min, measured according ISO1133 (230° C., 2.16 kg load). The preferred MFR₂ range depends on the final application. MFR₂ ranges can be adjusted by the methods known in the art, e.g. by adjusting the hydrogen feed into the process.

In one embodiment, the polypropylene has a melt flow rate MFR₂ from 3.0 to 20 g/10 min, more preferably 5.0 to 15 g/10 min. These MFR₂ values are in particular useful for preparing a cast or biaxially oriented polypropylene (BOPP) film.

According to another embodiment, the polypropylene has a melt flow rate MFR₂ from 0.5 to 5.0 g/10 min, more preferably 1.0 to 4.0 g/10 min or from 1.0 to 3.0 g/10 min. These MFR₂ values are in particular useful for preparing a blown film.

In general, process conditions for polymerizing propylene and comonomers in the presence of a Ziegler-Natta catalyst are commonly known to the skilled person or can easily be established on the basis of common general knowledge.

As already mentioned above, using the specific silane compound of formula (I) as an external donor and a solid catalyst component being free of any external carrier in combination with 1-butene as the higher alpha-olefin comonomer does not only result in a very efficient incorporation of said comonomer but also makes it possible to produce propylene polymer compositions having beneficial product properties, especially low XS values vs the amount of comonomer content in the polymer.

Apart from the specific external electron donor and a specific solid catalyst component as defined above, the Ziegler-Natta catalyst comprises typically an organometallic cocatalyst.

The organometallic cocatalyst may comprise at least one compound selected from a trialkylaluminum, a dialkyl aluminum chloride, an alkyl aluminum sesquichloride, or any mixture thereof. Preferably, alkyl is ethyl or isobutyl. Commonly used cocatalyst is triethyl aluminum.

In the Ziegler-Natta catalyst of the present invention, the molar ratio of aluminum (from the organometallic cocatalyst) to the transition metal of Group 4 to 6, preferably titanium (from the solid catalyst component), can vary over a broad range. Preferably, the molar ratio of aluminum to titanium in the Ziegler-Natta catalyst is from 10 to 1000, more preferably from 50 to 500.

In the Ziegler-Natta catalyst of the present invention, the molar ratio of the external donor to the transition metal of Group 4 to 6, preferably titanium (from the solid catalyst component) can vary over a broad range. Preferably, the molar ratio of the external donor to titanium in the Ziegler-Natta catalyst is from 1 to 100, more preferably from 5 to 50.

The polymerization process for the production of the polypropylene may be a continuous process or a batch process utilising known methods and operating in liquid phase, optionally in the presence of an inert diluent, or in gas phase or by mixed liquid-gas techniques.

The polypropylene may be produced by a single- or multistage polymerisation process such as bulk polymerization, gas phase polymerization, slurry polymerization, solution polymerization or combinations thereof using the Ziegler-Natta catalyst as described above.

The polypropylene can be made e.g. in one or two slurry bulk reactors, preferably in one or two loop reactor(s), or in a combination of one or two loop reactor(s) and at least one gas phase reactor. Those processes are well known to one skilled in the art.

If polymerization is performed in one or two loop reactors, the polymerization is preferably carried out in liquid propylene/l-butene mixtures at temperatures in the range from 20° C. to 100° C. Preferably, temperatures are in the range from 60° C. to 80° C. The pressure is preferably between 5 and 60 bar. In case propylene/1-butene/ethylene terpolymer is produced, ethylene is also fed to any of the reactor(s). The molecular weight of the polymer chains and thereby the melt flow rate of the polypropylene, is regulated by adding hydrogen.

The process may also comprise an in-line prepolymerization step.

The catalyst can also be pre-polymerized off-line with monomers, e.g. with ethylene, propylene, or vinylcyclohexane. The off-line pre-polymerization degree (in gram of polymer per gram of catalyst) can be between 0,5 and 100, preferably between 1 and 50.

The in-line prepolymerization can be conducted as bulk slurry polymerization in liquid propylene or propylene/l-butene mixtures, i.e. the liquid phase mainly comprises propylene and optionally 1-butene, with a minor amount of other reactants and optionally inert components dissolved therein. The in-line polymerization step can be conducted in a separate pre-polymerization reactor preceding the actual polymerization reactors. It can also be conducted under prepolymerization conditions as a starting step in the first actual polymerization reactor.

The in-line prepolymerization reaction is typically conducted at a temperature of 0 to 50° C., preferably from 10 to 45° C.

If an in-line prepolymerisation step is carried out, it is possible that all catalyst components are introduced to the prepolymerization reactor. However, in principle, it is also possible that only a part of the cocatalyst is introduced into the prepolymerization stage and the remaining part into subsequent polymerization stages.

Hydrogen may be added into the prepolymerization stage to control the molecular weight of the prepolymer as is known in the art. Further, an antistatic additive may be used to prevent the particles from adhering to each other or to the walls of the reactor. The precise control of the prepolymerization conditions and reaction parameters is within the skill of the art.

According to a further aspect, the present invention relates to a propylene polymer composition (polypropylene), which is obtainable by the process as described above.

With regard to the preferred properties of the propylene polymer composition, reference can be made to the statements already made above.

According to a further aspect, the present invention relates to a film, comprising the propylene polymer composition as described above. The film can be oriented, either mono-axially or bi-axially. Alternatively, the film can be non-oriented.

Preferably, the film is selected from a blown film, a cast film or a BOPP film.

The film can be a layer, more preferably a sealing layer, in a multilayered biaxially oriented polypropylene (BOPP) film. So, according to another preferred embodiment, the present invention provides a multilayered biaxially oriented polypropylene (BOPP) film comprising a sealing layer which comprises the polypropylene as described above.

According to a further aspect, the present invention relates to a process for preparing a polypropylene film, which comprises
preparing a propylene polymer composition by the polymerisation process described above, and
processing the propylene polymer composition to a film.

The propylene polymer composition can be processed to a film by commonly known methods such as blow moulding, cast moulding, and extrusion moulding.

According to a further aspect, the present invention relates to the use of a Ziegler-Natta catalyst which comprises
i) an external donor of the following formula (I)

(R³)_{z}(R²O)_{y}Si(R¹)ₓ (I)

wherein
x is 1; y is 2 or 3; and z is 0 or 1; under the provision that x+y+z=4;
R¹ is an organic residue of the following formula (II)

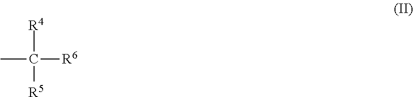

wherein
the carbon atom bonded to the Si atom is a tertiary carbon atom and each of the residues R⁴, R⁵ and R⁶ bonded to the tertiary carbon atom is, independently from each other, a C₁₋₄ alkyl, or two of R⁴, R⁵ and R⁶, together with the tertiary carbon atom C they are attached to, can be part of a carbocycle of 4-10 carbon atoms;
R² is a linear C₁₋₄ alkyl and
R³ is a C₁₋₄ alkyl, and
ii) a solid Ziegler-Natta catalyst component, which is free of any external carrier material,
   for manufacturing a propylene polymer composition which comprises a C4 to C10 α-olefin, preferably C4 to C6 α-olefin, most preferably 1-butene-derived comonomer units in an amount of from 0,5 to 15 wt % and ethylene-derived comonomer units in an amount of 0 wt-% to 3 wt %.

With regard to the preferred features of the Ziegler-Natta catalyst and the propylene polymer composition, reference is be made to the statements provided above.

The present invention will now be described in further detail by the following Examples.

### EXAMPLES

### Measuring Methods

If not otherwise indicated, the parameters mentioned in the present application are measured by the methods outlined below.

### 1. Comonomer Content by IR Spectroscopy

The content of 1-butene was measured by quantitative Fourier transform infrared spectroscopy (FTIR), as described in the following.

Before measuring, the stabilized powder was pressed in a press as follows:

Press Settings to Homogenise the Material:
press temperature: 210° C.
melting time: 90 sec
cooling rate: 12° C./min
de-moulding temperature: between 35 and 45° C.

| step | 1 | 2 (cooling) |
|---|---|---|
| duration (sec.) | 90 | 900 |
| Temperature (° C.) | 210 | 30 |
| pressure (bar) | 0 | 0 |

### Press Settings for IR Plate:

press temperature: 210° C.
melting time: 45 sec
press pressure: 3 steps (10/30/90 bar)
cooling rate: 12° C./min
de-moulding temperature: between 35 and 45° C.

| step | 1 | 2 | 3 | 4 | 5 (cooling) |
|---|---|---|---|---|---|
| duration (sec.) | 45 | 15 | 15 | 15 | 900 |
| Temperature (° C.) | 210 | 210 | 210 | 210 | 30 |
| pressure (bar) | 0 | 10 | 30 | 90 | 90 |

The films had a thickness of between 260 and 300 μm

Spectra have been recorded in transmission mode. Relevant instrument settings include a spectral window of 5000 to 400 wave-numbers (cm⁻¹), a resolution of 2.0 cm⁻¹ and 16 scans. The butene content of the propylene-butene copolymers was determined using the baseline corrected peak maxima of a quantitative band at 767 cm⁻¹, with the baseline defined from 1945 to 625 cm⁻¹. The comonomer content in mol % was determined using a film thickness method using the intensity of the quantitative band I₇₆₇ (absorbance value) and the thickness (T, in cm) of the pressed film using the following relationship:

mol % C4=[(I₇₆₇/T)−1.8496]/1.8233 (Equation 1)

In the case of C3C4C2 terpolymers, the comonomer content was determined using the baseline corrected peak maxima of the quantitative bands at 767 cm⁻¹ for butene and at 732 cm⁻¹ for ethylene with the baseline defined from 1945 to 625 cm⁻¹. The comonomer content in mol % was determined using a film thickness method using the intensity of the quantitative bands (I₇₆₇ and I₇₃₂ absorbance values) and the thickness (T, in cm) of the pressed film using the following relationships:

mol % C4=[(I₇₆₇/T)−3.1484]/1,5555 (Equation 2)

mol % C2=[(I₇₃₂/T)−0,6649]/1,2511 (Equation 3)

### 2. Amount of Xylene Solubles (XS, wt %)

The amount of xylene solubles was determined based on the principles of ISO 16152; first edition; 2005-Jul. 2001. at 25° C., but using the following conditions: A weighed amount of a sample was dissolved under reflux conditions for 1 h. The solution was first cooled for 60 min at room temperature and then maintained at 25° C. for 200 min to achieve the complete crystallization of the insoluble fraction. After filtration and solvent evaporation the amount of xylene soluble fraction was gravimetrically determined.

### 3. MFR₂

Melt flow rate MFR₂ was measured according to ISO 1133 (230° C., 2.16 kg load).

### 4. Melting Temperature

The melting points (Tm) were determined according to ISO standards 11357 on a DSC Q2000 T A Instrument, by placing a 5-7 mg polymer sample, into a closed DSC aluminum pan, heating the sample from −10° C. to 225° C. at 10° C./min, holding for 10 min at 225° C., cooling from 225° C. to −10° C., holding for 5 min at −10° C., heating from −10° C. to 225° C. at 10° C./min. The reported values are those of the peak of the endothermic heat flow determined from the second heating scan.

### 5. ICP Analysis

The elemental analysis of a catalyst was performed by taking a solid sample of mass, M, cooling over dry ice. Samples were diluted up to a known volume, V, by dissolving in nitric acid (HNO₃, 65%, 5% of V) and freshly deionised (DI) water (5% of V). The solution was further diluted with DI water up to the final volume, V, and left to stabilize for two hours.

The analysis was run at room temperature using a Thermo Elemental iCAP 6300 Inductively Coupled Plasma-Optical Emmision Spectrometer (ICP-OES) which was calibrated using a blank (a solution of 5% HNO₃), and standards of 0.5 ppm, 1 ppm, 10 ppm, 50 ppm, 100 ppm and 300 ppm of Al, Mg and Ti in solutions of 5% HNO₃.

Immediately before analysis the calibration is ‘resloped’ using the blank and 100 ppm standard, a quality control sample (20 ppm Al, Mg and Ti in a solution of 5% HNO₃ in DI water) is run to confirm the reslope. The QC sample is also run after every 5^{th} sample and at the end of a scheduled analysis set.

The content of Mg was monitored using the 285.213 nm line and the content for Ti using 336.121 nm line. The content of aluminium was monitored via the 167.079 nm line, when Al concentration in ICP sample was between 0-10 ppm (calibrated only to 100 ppm) and via the 396.152 nm line for Al concentrations above 10 ppm. The reported values are an average of three successive aliquots taken from the same sample and are related back to the original catalyst by inputting the original mass of sample and the dilution volume into the software.

6. Surface area: BET with N2 gas ASTM D 3663, apparatus Micromeritics Tristar 3000: sample preparation at a temperature of 50° C., 6 hours in vacuum.
7. Pore volume was measured according to ASTM 4641.
8. Mean particle size is given in μm and measured with Coulter Counter LS200 at room temperature with n-heptane as medium. The given mean particle size is arithmetic mean size and is based on volumetric amount.

### Polymerisation Experiments

The external donors as disclosed in Table 1 were used in the examples. In Inventive examples external donors ID0, ID1 and ID3 were used, and in comparative examples external donors D, C and CD4 were used.

TABLE 1

| Acro- | | | |
|---|---|---|---|
| nym | structure | name | CAS# |
| D | 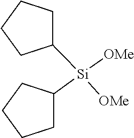 [SMILES: CO[Si](OC)(C1CCCC1)C1CCCC1] | Dicyclopentyl dimethoxy silane | 126990-35-0 |
| C | 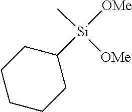 | Cyclo- hexyl(methyl) dimethoxy silane | 17865-32-6 |
| CD4 | 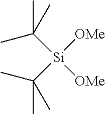 | di-tert-butyl- dimethoxy silane | 79866-98-1 |
| ID0 | 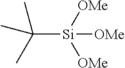 | tert-butyl trimethoxy silane | 18395-29-4 |
| ID1 | 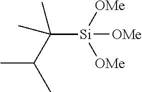 | trimethoxy(1,1,2- trimethylpropyl) silane or thexyl trimethoxy silane | 142877-45-0 |
| ID3 | 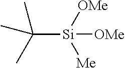 | tert-butyl di- methoxy(methyl) silane | 18293-81-7 |

The following solid Ziegler-Natta catalyst components were used in the Examples:

### Catalyst 1

The solid catalyst component was prepared by emulsion-solidification method according to Example 8 of WO 2004/029112, except that diethylaluminum chloride was used as an aluminium compound instead of triethylaluminum. Ti content was 2.9 wt-%. Surface area is <5 m²/g (below the detection limit).

### Catalyst 2

The solid catalyst component was prepared by emulsion-solidification method as follows:

3.4 litre of 2-ethylhexanol and 810 ml of propylene glycol butyl monoether (in a molar ratio 4/1) were added to a 20 l reactor. Then 7.8 litre of a 20% solution in toluene of BEM (butyl ethyl magnesium) provided by Crompton GmbH, were slowly added to the well stirred alcohol mixture. During the addition the temperature was kept at 10° C. After addition the temperature of the reaction mixture was raised to 60° C. and mixing was continued at this temperature for 30 minutes. Finally after cooling to room temperature the obtained Mg-alkoxide was transferred to a storage vessel.
21.2 g of Mg alkoxide prepared above was mixed with 4.0 ml bis(2-ethylhexyl) citraconate for 5 min. After mixing the obtained Mg complex was used immediately in the preparation of the catalyst component.
19.5 ml of titanium tetrachloride was placed in a 300 ml reactor equipped with a mechanical stirrer at 25° C. Mixing speed was adjusted to 170 rpm. 26.0 g of Mg-complex prepared above was added within 30 minutes keeping the temperature at 25° C. 3.0 ml of Viscoplex® 1-254 and 1.0 ml of a toluene solution with 2 mg Necadd 447™ was added. Then 24.0 ml of heptane was added to form an emulsion. Mixing was continued for 30 minutes at 25° C., after which the reactor temperature was raised to 90° C. within 30 minutes. The reaction mixture was stirred for a further 30 minutes at 90° C. Afterwards stirring was stopped and the reaction mixture was allowed to settle for 15 minutes at 90° C. The solid material was washed 5 times: Washings were made at 80° C. under stirring for 30 min with 170 rpm. After stirring was stopped the reaction mixture was allowed to settle for 20-30 minutes and followed by siphoning.
   Wash 1: Washing was made with a mixture of 100 ml of toluene and 1 ml donor
   Wash 2: Washing was made with a mixture of 30 ml of TiCl4 and 1 ml of donor.
   Wash 3: Washing was made with 100 ml of toluene.
   Wash 4: Washing was made with 60 ml of heptane.
   Wash 5: Washing was made with 60 ml of heptane under 10 minutes stirring.

Afterwards stirring was stopped and the reaction mixture was allowed to settle for 10 minutes while decreasing the temperature to 70° C. with subsequent siphoning, followed by N2 sparging for 20 minutes to yield an air sensitive powder. Ti content was 3.76 wt-%. The catalyst was prepared without any phthalic compounds. Surface area is <5 m²/g (below the detection limit).

### Catalyst 3 (Comparative)

MgCl₂ supported catalyst-comparative catalyst

First, 0.1 mol of MgCl₂×3 EtOH was suspended under inert conditions in 250 ml of decane in a reactor at atmospheric pressure. The solution was cooled to the temperature of −15° C. and 300 ml of cold TiCl₄ was added while maintaining the temperature at said level. Then, the temperature of the slurry was increased slowly to 20° C. At this temperature, 0.02 mol of dioctylphthalate (DOP) was added to the slurry. After the addition of the phthalate, the temperature was raised to 135° C. during 90 minutes and the slurry was allowed to stand for 60 minutes. Then, another 300 ml of TiCl₄ was added and the temperature was kept at 135° C. for 120 minutes. After this, the catalyst was filtered from the liquid and washed six times with 300 ml heptane at 80° C. Then, the catalyst was filtered and dried. Catalyst and its preparation concept is described in general e.g. in patent publications EP491566, EP591224 and EP586390. Ti content in the catalyst component was 1.9 wt-%.

### Description of Catalyst Pre-Activation

In the glove-box, a defined amount of catalyst previously slurried in white oil, was well homogenized at least for 20 min by shaking. Then the chosen amount of the catalyst-oil slurry sample was drawn with a syringe and transferred into a 20 ml stainless steel vial with 10 ml heptane. 80% of the total TEA (triethylaluminium) solution (0,62 molar solution in heptane provided by Chemtura) and the whole donor amount (0.3 molar solution in heptane) were mixed for 5 minutes in an appropriate syringe and injected into the catalyst vial which was then mounted on the autoclave.

### Polymerisation Procedures

In all Examples, triethylaluminium (TEA) was used as the organometallic cocatalyst.

### Propylene-1-Butene Copolymerisation

A stirred autoclave reactor equipped with a ribbon stirrer, with a volume of 21,2-L containing 0.2 bar-g propylene pressure was filled with 3.45 kg propylene and the desired amount of 1-butene. After adding 20% of the total TEA solution by flushing it into the reactor with 250 g propylene, the chosen amount of H2 was added via mass flow controller (MFC). The solution was stirred at 20° C. and 250 rpm. After a total contact time of 5 min between the oil catalyst slurry in heptane and the TEA/Donor solution, the catalyst slurry was injected by means of 250 g propylene. Pre-polymerisation was run for 10 min. The polymerisation temperature was then increased to 75° C. and kept constant throughout the polymerisation experiment. The reactor pressure was also kept constant by feeding propylene throughout the polymerisation experiment at 75° C. The polymerisation time was measured starting when the temperature reached 73°. After 1 hour the reaction was stopped by adding 5 ml methanol, cooling the reactor and flashing the volatile components.

After purging the reactor twice with N2 and one vacuum/N2 cycle, the product was taken out and dried overnight in a fume hood. 100 g of the polymer was additivated with 0.2 wt % Ionol and 0.1 wt % PEPQ (dissolved in acetone) and then dried overnight in a hood plus 2 hours in a vacuum drying oven at 60° C.

### Propylene-1-Butene-Ethylene Terpolymerisation

A stirred autoclave reactor equipped with a ribbon stirrer, with a volume of 21,2-L containing 0.2 bar-g propylene pressure was filled with 3.45 kg propylene and the chosen amount of 1-butene (see tables). Afterwards 20% of the total amount of TEA was injected in a stainless-steel vial having a total volume of about 2 ml. This vial was mounted on the reactor and the solution was injected into the reactor by flushing with 250 g propene. After a contact time of about 20 min between TEA and the monomers (at 20° C., 250 rpm), the catalyst vial (catalyst feeder) was mounted on the reactor. Then the chosen amount of H2 was added via mass flow controller (MFC) in the reactor. The solution was stirred at 250 rpm and 20° C. After a total contact time of 5 min between the catalyst oil slurry and the TEA/Donor solution in the catalyst feeder, the suspension was injected by flushing with 250 g propylene. Stirring speed was kept at 250 rpm and pre-polymerisation was run for 10 minutes at 20° C. The polymerisation temperature was then increased to 70° C. and kept constant throughout the polymerisation. During the reactor heating-up phase, a defined amount of ethylene was added (see Tables). The polymerisation time was measured starting when the reactor temperature reached 68° C. Ethylene was dosed continuously via MFC at a fixed rate and the reactor pressure was kept constant by feeding propylene throughout the polymerisation experiment at 70° C.

After 1 hour, the reaction was stopped by adding 5 ml methanol, cooling the reactor and flashing the volatile components. After purging the reactor twice with N2 and one vacuum/N2 cycle, the product was taken out and dried overnight in a fume hood. 100 g of the polymer was additivated with 0.2 wt % Ionol and 0.1 wt % PEPQ (dissolved in acetone) and then dried overnight in a hood plus 2 hours in a vacuum drying oven at 60° C.

The polymerization conditions and polymer properties of the propylene-1-butene copolymers are shown in Tables 2 and 3.

The polymerization conditions and polymer properties of the propylene-1-butene-ethylene terpolymers are shown in Tables 4 (4a and 4b) and 5.

### Calculations:

The calculations for the C4 concentrations in the liquid phase were done by using the Aspen General VLE 8.2 model RRT.

The C4 concentration values used to estimate the reactivity ratio R was calculated according to the following equation:

Ratio C4/C3 w/w in liquid phase=(ratio C4/C3 w/w at start+ratio C4/C3 w/w at end of experiment)/2

The reactivity ratio R was calculated according to the following Equation:

Reactivity Ratio R=(ratio C4/C3w/w in polymer)/(ratio C4/C3w/w in liquid phase)

TABLE 2
Polymerization conditions in propylene-1-butene polymerization

| | | | | | Av. calculated |
|---|---|---|---|---|---|
| | | | | | C4/C3 |
| | | | | | wt- ratio in |
| | Catalyst | External | Al/Ti | Donor/Ti | liquid phase |
| Example | component | donor | mol/mol | mol/mol | wt/wt |
| InvEx1 | 1 | ID0 | 250 | 25 | 0.25 |
| InvEx2 | 1 | ID3 | 250 | 25 | 0.26 |
| InvEx3 | 2 | ID0 | 100 | 20 | 0.25 |
| InvEx4 | 2 | ID3 | 100 | 20 | 0.26 |
| CompEx1 | 1 | D | 250 | 25 | 0.25 |
| CompEx2 | 1 | CD4 | 250 | 25 | 0.26 |
| CompEx3 | 2 | D | 100 | 20 | 0.25 |
| CompEx4 | 2 | CD4 | 100 | 20 | 0.25 |
| CompEx5 | 3 | D | 250 | 25 | 0.26 |
| CompEx6 | 3 | ID0 | 250 | 25 | 0.26 |
| CompEx7 | 3 | ID3 | 250 | 25 | 0.26 |
| CompEx8 | 3 | CD4 | 250 | 25 | 0.26 |

TABLE 3
Polymer properties of propylene-1-butene copolymers
and 1-butene reactivity ratio R

| | | | | C4 | | | |
|---|---|---|---|---|---|---|---|
| | | | MFR₂ | total | | | |
| | Catalyst | External | g/10 | (IR) | XS | Tₘ | |
| Example | component | Donor | min | wt % | wt % | ° C. | R |
| InvEx1 | 1 | ID0 | 6.8 | 6.5 | 2.6 | 144.9 | 0.27 |
| InvEx2 | 1 | ID3 | 9.0 | 6.8 | 3.4 | 145.1 | 0.28 |
| InvEx3 | 2 | ID0 | 7.0 | 6.8 | 1.9 | 145.4 | 0.29 |
| InvEx4 | 2 | ID3 | 7.5 | 7.5 | 2.0 | 143.5 | 0.32 |
| CompEx1 | 1 | D | 4.9 | 5.6 | 2.5 | 148.2 | 0.23 |
| CompEx2 | 1 | CD4 | 6.3 | 7.0 | 5.8 | 144.6 | 0.29 |
| CompEx3 | 2 | D | 5.6 | 5.5 | 2.0 | 149.4 | 0.23 |
| CompEx4 | 2 | CD4 | 4.4 | 7.3 | 3.9 | 144.3 | 0.31 |
| CompEx5 | 3 | D | 2.0 | 4.9 | 1.6 | 152.0 | 0.20 |
| CompEx6 | 3 | ID0 | 4.4 | 5.5 | 2.1 | 150.3 | 0.23 |
| CompEx7 | 3 | ID3 | 5.6 | 6.2 | 2.2 | 149.2 | 0.25 |
| CompEx8 | 3 | CD4 | 2 | 6.0 | 3.4 | 149.4 | 0.25 |

TABLE 4a
Polymerization conditions (catalyst) in propylene-1-butene-ethylene terpolymerisation:

| | | | | TEA solution | Total TEA | | TEA | | |
|---|---|---|---|---|---|---|---|---|---|
| | | | | in precontact | solution | | solution in | | |
| | | | Catalyst | (0.62 molar | (0.62 molar | Donor amount | purification | | |
| Example | | External | amount | in C7) | in C7) | (0.3 molar) | step | Al/Ti | Donor/Ti |
| # | Catalyst | Donor | mg | ml | ml | ml | mmol | mol/mol | mol/mol |
| CompEx9 | 2 | D | 58.1 | 7.98 | 9.97 | 2.06 | 1.237 | 200 | 20 |
| InvEx5 | 2 | ID3 | 64.9 | 8.92 | 11.15 | 2.30 | 1.383 | 200 | 20 |
| InvEx6 | 2 | ID3 | 58.1 | 7.98 | 9.97 | 2.06 | 1.237 | 200 | 20 |
| InvEx7 | 2 | ID1 | 57.0 | 7.83 | 9.79 | 2.02 | 1.214 | 200 | 20 |

TABLE 4b
Polymerization conditions in propylene-1-butene-ethylene terpolymerisation:

| | | | | | | | | | average | average | | |
|---|---|---|---|---|---|---|---|---|---|---|---|---|
| | | | | | | | | | calculated | calculated | | |
| | | | | | | | | | C4/C3 | C4/(C3 + C4) | | |
| | | C3 dosed to | | C3 total | | C2 feed | | | wt-ratio | wt-ratio | | Catalyst |
| | | keep pressure | C3 total | from scale and | C4 total | const flow | C2 feed | C2 feed | in liquid | in liquid | | activity |
| Example | H2 | constant | from scale | flowcontrol | from scale | transition | batch | total | phase | phase | yield | kgPP/ |
| # | NL | g | g | g | g | g | g | g | g/g | wt % | g | gcat/h |
| CompEx9 | 15 | 1291 | 3965 | 5256 | 927 | 8 | 15 | 23 | 0.27 | 21.26 | 2323 | 40.0 |
| InvEx5 | 13 | 1331 | 3965 | 5296 | 927 | 8 | 15 | 23 | 0.27 | 21.26 | 2490 | 38.3 |
| InvEx6 | 13 | 1080 | 3965 | 5045 | 927 | 8 | 15 | 23 | 0.27 | 20.95 | 2070 | 35.6 |
| InvEx7 | 13 | 1157 | 3965 | 5122 | 927 | 8 | 15 | 23 | 0.27 | 21.32 | 2444 | 42.9 |

TABLE 5
Polymer properties of propylene-1-butene-ethylene terpolymerisations and 1-butene reactivity ratio R

| | | | Bulk | | C4 | C2 | | | | | |
|---|---|---|---|---|---|---|---|---|---|---|---|
| | External | MFR2 | density | XS | (IR) | (IR) | R | Tₘ | T_{c} | M_{w} | |
| Example | Donor | g/10 min | g/ml | wt % | wt % | wt % | (C4/C3) | ° C. | ° C. | g/mol | M_{w}/Mₙ |
| CompEx9 | D | 7.5 | 0.45 | 3.9 | 6.2 | 0.8 | 0.24 | 142.1 | 101.3 | 254500 | 7.1 |
| InvEx5 | ID3 | 10 | 0.46 | 3.4 | 7.7 | 0.8 | 0.31 | 136.2 | 97.9 | 231000 | 5.7 |
| InvEx6 | ID3 | 8.5 | 0.46 | 3.4 | 7.8 | 0.9 | 0.32 | 136.6 | 96.2 | 243000 | 5.7 |
| InvEx7 | ID1 | 7.9 | 0.45 | 2.9 | 8.2 | 0.7 | 0.33 | 136.5 | 96.1 | 280800 | 6.6 |

When evaluating a catalyst for its copolymerization performance, the most useful parameter to determine is the relative comonomer reactivity ratio R, which is defined as indicated above.

R is specific for a given catalyst and monomer pair and typically applies to the whole composition range. Since the concentration of 1-butene increases over the polymerization time while that of propylene decreases, there is a significant difference in liquid phase composition between start and end of the polymerisation experiment. For this reason, as liquid phase composition values, the average of the initial and final calculated values was used.

The values of R determined for propylene-1-butene polymerisations with the Ziegler-Natta catalyst comprising as the external donor donor D, R is 0,23 with the same catalyst components 1 and 2 as used in the inventive examples, and only 0,2 with supported catalyst component 3. The Ziegler-Natta catalyst comprising as the external donor donor ID0 or ID3 R is 0,27 to 0,32 with the catalyst components 1 and 2, and only 0,23 and 0,25 for supported catalyst component 3. These results show that the external donor of the present invention increases the 1-butene reactivity of the Ziegler-Natta catalyst and still the XS value is low. In those comparative examples where R is on the same level as in inventive examples (external donor is CD4), XS values are, however, clearly higher than in inventive examples. In all other comparative examples R is clearly lower than in inventive examples.

In terpolymer examples R is clearly lower in the comparative example (catalyst 2 and external donor D) than in the inventive examples (catalyst 2, external donors ID1 and ID3). XS is also higher in the comparative example.

As demonstrated above, the Ziegler-Natta catalyst comprising the external donor as defined in the present invention and a solid catalyst component being free of any external carrier material has a very high reactivity for 1-butene, thereby requiring less 1-butene in the monomer feed. This means that less unreacted 1-butene has to be removed from the final polymer, with the operability advantage of reducing the degassing time, and resulting in a higher throughput.

1. An olefin polymerization process, wherein propylene and C4 to C10 α-olefin and optionally ethylene are reacted in the presence of a Ziegler-Natta catalyst so as to obtain a propylene polymer composition,
wherein the polypropylene comprises C4 to C10 α-olefin-derived comonomer units in an amount of from 0.5 wt % to 15 wt % and ethylene-derived comonomer units in an amount of 0 wt % to 3 wt %, and
the Ziegler-Natta catalyst comprises
i) an external donor of the following formula (I):
(R³)_{z}(R²O)_{y}Si(R¹)ₓ (I)
wherein
x is 1; y is 2 or 3; and z is 0 or 1; under the provision that x+y+z=4;
R¹ is an organic residue of the following formula (II): 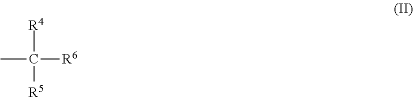
wherein
the carbon atom bonded to the Si atom is a tertiary carbon atom and each of the residues R⁴, R⁵ and R⁶ bonded to the tertiary carbon atom is, independently from each other, a C₁₋₄ alkyl, or two of R⁴, R⁵ and R⁶, together with the tertiary carbon atom C they are attached to can be part of a carbocycle of 4-10 carbon atoms;
R² is a linear C₁₋₄ alkyl
R³ is a C₁₋₄ alkyl and
ii) a solid Ziegler-Natta catalyst component, which is free of any external carrier material.

2. The process according to claim 1, wherein y is 2 or 3, z is 0 or 1, R² is a linear C₁₋₄ alkyl R³ is C₁₋₄ alkyl, R⁴, R⁵ and R⁶ are independently from each other linear C₁₋₄ alkyl.

3. The process according to claim 1, wherein the propylene polymer composition comprises 2 to 12 wt % C4 to C10 α-olefin derived comonomer units and optionally 0.5 wt % to 2.5 wt % of ethylene.

4. The process according to claim 1, wherein the propylene polymer composition is a propylene-1-butene copolymer or propylene-1-butene-ethylene terpolymer composition.

5. The process according to claim 1, wherein the propylene-1-butene copolymer has an amount of xylene solubles of 3.5 wt % or less;

6. The process according to claim 1, wherein particles of the solid Ziegler-Natta catalyst component ii) have a surface area less than 20 m²/g.

7. The process according to claim 1, wherein the solid Ziegler-Natta catalyst component ii) is obtainable or obtained by the method where no external carrier material is used and comprising the steps:
A) preparing a solution of Group 2 metal complex by reacting a Group 2 metal alkoxy compound and an electron donor or a precursor thereof in a reaction medium comprising C₆-C₁₀ aromatic liquid;
B) reacting said Group 2 metal complex with at least one compound of a transition metal of Group 4 to 6, and
C) obtaining the solid catalyst component particles.

8. The process according to claim 1, wherein the solid Ziegler-Natta catalyst component ii) is free of any phthalic compounds.

9. The process according to claim 1, wherein the solid Ziegler-Natta catalyst component ii) is prepared according to the procedure comprising:
a) providing a solution of:
a₁) at least a Group 2 metal alkoxy compound (Ax), which is the reaction product of a Group 2 metal compound and an alcohol (A) comprising in addition to the hydroxyl moiety at least one ether moiety optionally in an organic liquid reaction medium; or
a₂) at least a Group 2 metal alkoxy compound (Ax′), which is the reaction product of a Group 2 metal compound and an alcohol mixture of the alcohol (A) and a monohydric alcohol (B) of formula ROH, optionally in an organic liquid reaction medium; or
a₃) a mixture of the Group 2 metal alkoxy compound (Ax) and a Group 2 metal alkoxy compound (Bx), which is the reaction product of a Group 2 metal compound and the monohydric alcohol (B), optionally in an organic liquid reaction medium; or
a₄) Group 2 metal alkoxy compound of formula M(OR₁)ₙ(OR₂)ₘX₂₋ₙ₋ₘ or mixture of Group 2 alkoxides M(OR₁)_{n′}X₂₋ₙ, and M(OR₂)_{m′}X_{2-m′}, where M is Group 2 metal, X is halogen, R₁ and R₂ are different alkyl groups of C₂ to C₁₆ carbon atoms, and 0≤n<2; 0≤m<2 and n+m≤2, provided that both n and m≠0, 0<n′≤2 and 0<m′≤2; and
b) adding said solution from step a) to at least one compound of a transition metal of Group 4 to 6 and
c) obtaining the solid catalyst component particles, and
adding a non-phthalic internal electron donor at any step prior to step c).

10. The process according to claim 1, wherein the solid Ziegler-Natta catalyst component is prepared by an emulsion-solidification method.

11. The process according to claim 1, wherein the propylene polymer composition is prepared in a process comprising a liquid phase polymerization.

12. A propylene polymer composition, obtainable by the process according to claim 1.

13. A film, comprising the propylene polymer composition according to claim 12.

14. The film according to claim 13, wherein the film is a blown film, a cast film, a biaxially oriented film, or any combination thereof.

15. The film according to claim 13, wherein the film is a multi-layered biaxially oriented film comprising a sealing layer.

16-17. (canceled)
